(19) United States
(12) Patent Application Publication
(10) Pub. No.: US 2018/0279834 A1
(43) Pub. Date: Oct. 4, 2018

(54) TRANSMISSION APPARATUS AND COOK MACHINE WITH TRANSMISSION APPARATUS

(71) Applicant: Shenzhen Muren Appliance Co., Ltd., Shenzhen (CN)

(72) Inventor: Wenxiong Wang, Shenzhen (CN)

(21) Appl. No.: 15/980,721

(22) Filed: May 15, 2018

Related U.S. Application Data
(63) Continuation of application No. PCT/CN2018/080851, filed on Mar. 28, 2018.

(30) Foreign Application Priority Data
Mar. 28, 2017 (CN) 201720309890.3

(51) Int. Cl. A47J 43/08; H02K 7/116; F16H 1/22

(52) U.S. Cl. CPC A47J 43/08; F16H 1/222; H02K 7/1163

(57) ABSTRACT

A transmission apparatus includes a DC motor, a level one transmission assembly, a level two transmission assembly, a level three transmission assembly, and a level four transmission assembly. The DC motor is connected to the level one transmission assembly, to drive the level one transmission assembly to act; the level one transmission assembly drives the level two transmission assembly to act; the level two transmission assembly drives the level three transmission assembly to act; the level three transmission assembly outputs kinetic energy and transforms a vertical motion into a horizontal motion through the level four transmission assembly. The transmission apparatus can output kinetic energy in many directions through a motor. One machine is endowed with a variety of machine functions. An output shaft of DC motor is directly connected to tapered gear, to make the structure more compact. A cook machine with the transmission apparatus is also provided.

### CROSS REFERENCE TO RELATED APPLICATIONS

The present application is a Continuation Application of PCT Application No. PCT/CN2018/080851 filed on Mar. 28, 2018, which claims the benefit of Chinese Patent Application No. 201720309890.3 filed on Mar. 28, 2017. The above is hereby incorporated by reference.

### FIELD

The subject matter herein generally relates to a field of kitchenware, in particular to a transmission apparatus and a cook machine with the transmission apparatus.

### BACKGROUND

A cook machine sold by a market has a working principle. The working principle of the cook machine is as follows: a motor transmits a stiffing force through a transmission apparatus, the motor drives the transmission apparatus to rotate after being powered on, and the corresponding accessories are connected to start the corresponding functions.

However, a prior cook machine is generally carried out through a belt and a belt wheel for transmitting the force, which will affect the compactness of the whole structure. Furthermore, a transmission apparatus of the prior cook machine has only one output shaft, a plurality of functions can be achieved at the same time and is not convenient to use the transmission apparatus of the prior cook machine.

### SUMMARY

The present disclosure aims to provide a transmission apparatus, to overcome the problems existing in the prior transmission apparatus of the background.

The present disclosure also aims to provide a cook machine with the transmission apparatus.

The purpose of the present disclosure is realized through the following technology:

A transmission apparatus comprises a direct current (DC) motor, a level one transmission assembly, a level two transmission assembly, a level three transmission assembly, and a level four transmission assembly; the DC motor is connected to the level one transmission assembly, to drive the level one transmission assembly to act; the level one transmission assembly drives the level two transmission assembly to act; the level two transmission assembly drives the level three transmission assembly to act; the level three transmission assembly outputs kinetic energy; the level three transmission assembly transforms a vertical motion into a horizontal motion through the level four transmission assembly, to output the kinetic energy. The transmission apparatus can output kinetic energy in many directions through a motor. One machine is endowed with a variety of machine functions. An output shaft of the DC motor is directly connected to a tapered gear, to make the structure more compact.

The present disclosure is also characterized in that:

The level one transmission assembly comprises a tapered gear, a gear wheel, and a first securing shaft, the tapered gear meshes the gear wheel, the gear wheel receives the first securing shaft, and the tapered gear is connected to an output shaft of the DC motor.

The level two transmission assembly comprises a first gear, a second gear, and a second securing shaft, the first gear meshes the second gear, the second gear receives the second securing shaft, and the first gear is coaxial with an output gear of the level one transmission assembly.

The first securing shaft receives plane bearing for bearing a vertical force from the tapered gear, the plane bearing is located between the gear wheel and the first gear, the plane bearing comprises an upper washer, a lower washer, and a ball clip arranged between the upper washer and the lower washer, a bore diameter of the upper washer is less than a bore diameter of the lower washer.

The level three transmission assembly comprises a third gear, a fourth gear, and a vertical output shaft, the third gear meshes the fourth gear, the fourth gear receives the vertical output shaft, and the third gear is coaxial with the second gear.

The level four transmission assembly comprises a fifth gear, a sixth gear, and a horizontal output shaft, the fifth gear meshes the sixth gear, the fifth gear receives the vertical output shaft of the level three transmission assembly, the sixth gear receives the horizontal output shaft.

The transmission apparatus is arranged in a case.

The first securing shaft is secured to an inner top portion of the case.

A front end of the horizontal output shaft fits an assembly hole of one side of the case.

Each of the tapered gear, the gear, the fifth gear, and the sixth gear, uses a helical bevel gear, both the second gear and the third gear use an inclined gear.

A cook machine comprises the transmission apparatus and a cook machine body, the transmission apparatus is connected to the cook machine body.

Compared with the prior art, when the present technology is used, firstly, with the transmission of the DC motor, the level one transmission assembly, the level two transmission assembly, the level three transmission assembly and the level four transmission assembly, the cook machine can output kinetic energy in a horizontal direction and in a vertical direction at the same time. Thus, one machine is endowed with a variety of machine functions. Secondly, avoid the use of a belt and a belt wheel, to make the whole structure more compact. Finally, the DC motor can be used to adjust the speed of the transmission apparatus, thereby enabling the cook machine to meet a variety need of users.

### BRIEF DESCRIPTION OF THE DRAWINGS

Implementations of the present technology will now be described, by way of example only, with reference to the figures.

FIG. 1 is a plan view of a first exemplary embodiment of a transmission apparatus.

FIG. 2 is a rear view of the first exemplary embodiment of the transmission apparatus.

FIG. 3 is a top view of the first exemplary embodiment of the transmission apparatus.

FIG. 4 is a plan view of a second exemplary embodiment of the transmission apparatus.

FIG. 5 is a rear view of the second exemplary embodiment of the transmission apparatus.

FIG. 6 is a structure schematic diagram of one exemplary embodiment of a cook machine.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiment described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

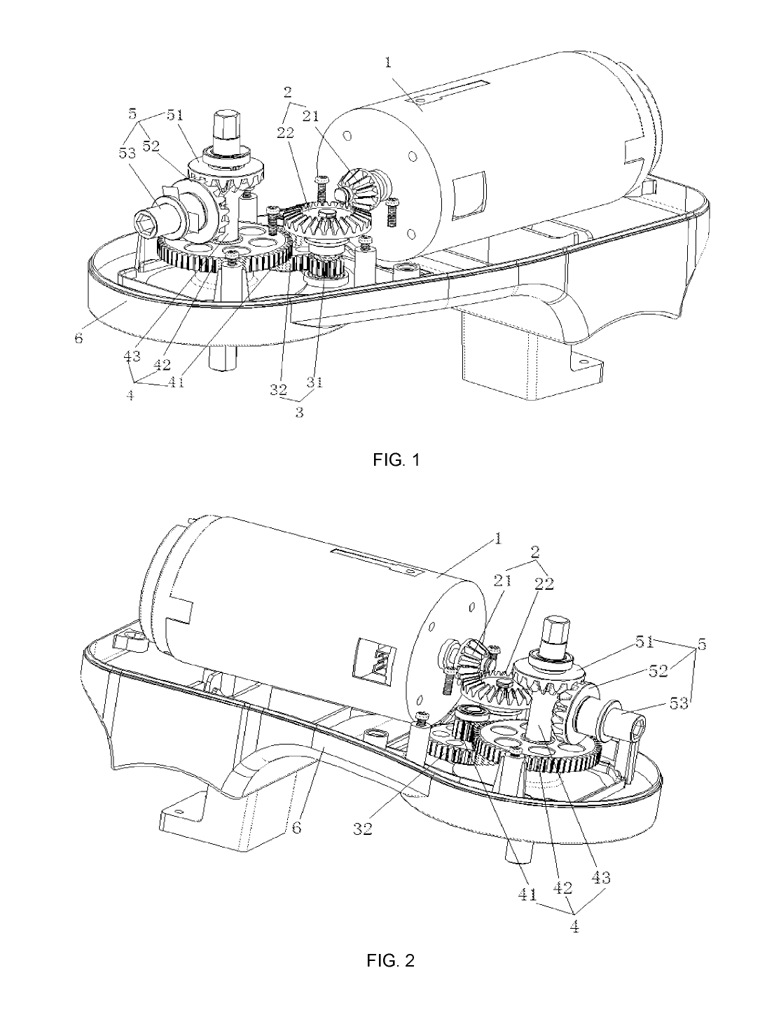

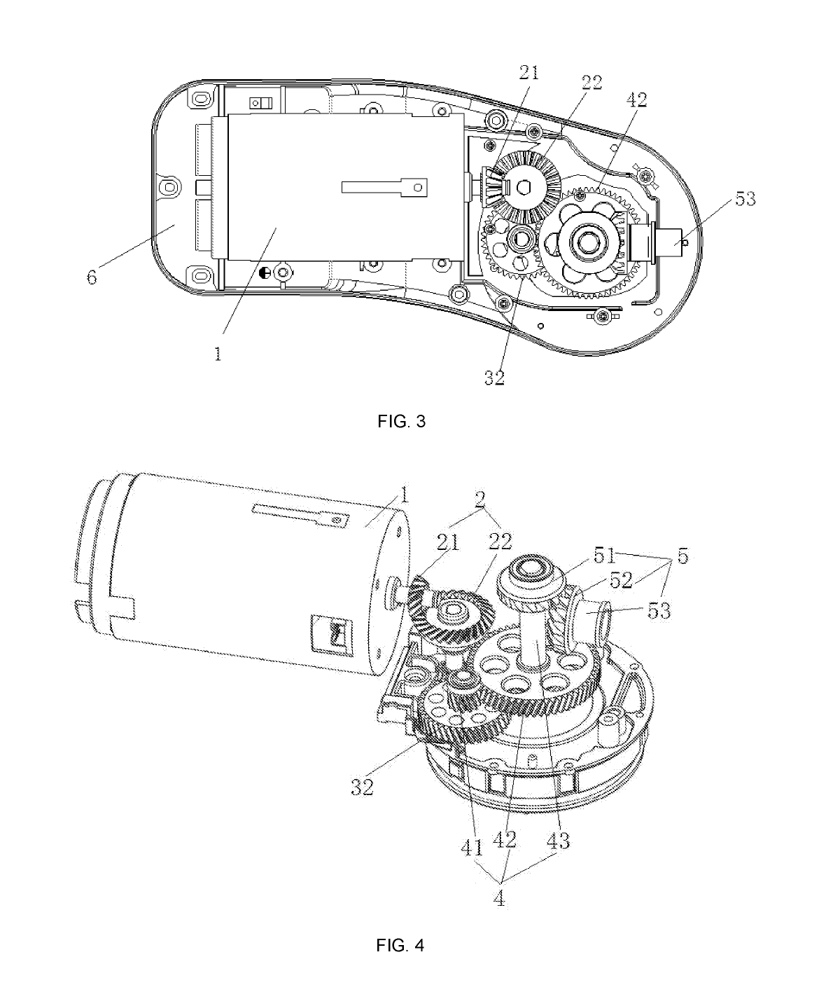

FIGS. 1-3 illustrate a first exemplary embodiment of a transmission apparatus. The transmission apparatus comprises a direct current (DC) motor 1, a level one transmission assembly 2, a level two transmission assembly 3, a level three transmission assembly 4, and a level four transmission assembly 5. The DC motor 1 is connected to the level one transmission assembly 2, to drive the level one transmission assembly 2 to act. The level one transmission assembly 2 drives the level two transmission assembly 3 to act. The level two transmission assembly 3 drives the level three transmission assembly to act. The level three transmission assembly 4 outputs kinetic energy. The level three transmission assembly 4 transforms a vertical motion to a horizontal motion through the level four transmission assembly 5, to realize to output the kinetic energy, thereby realizing to output the kinetic energy in the horizontal direction and the vertical direction at the same time. The DC motor 1 can be used to adjust the speed of the transmission apparatus, thereby enabling the cook machine to meet a variety need of users.

The level one transmission assembly 2 comprises a tapered gear 21, a gear wheel 22, and a first securing shaft. The gear wheel 22 receives the first securing shaft. The tapered gear 21 meshes the gear wheel 22. The tapered gear 21 is connected to an output shaft of the DC motor 1, thus, the tapered gear 21 is directly connected to an output shaft of the DC motor 1, thereby enabling to avoid the use of a belt and a belt wheel, to make the whole structure more compact.

The level two transmission assembly 3 comprises a first gear 31, a second the gear 32, and a second securing shaft. The first gear 31 meshes the second gear 32. The second gear 32 receives the second securing shaft. The first gear 31 is coaxial with the second gear 32, thus, the force of the level one transmission assembly 2 can be transmitted through the level two transmission assembly 3.

The first securing shaft receives plane bearing for bearing a vertical force from the tapered gear 21. The plane bearing is located between the gear wheel 22 and the first gear 31. The plane bearing comprises an upper washer, a lower washer, and a ball clip arranged between the upper washer and the lower washer. A bore diameter of the upper washer is less than a bore diameter of the lower washer. Thus, to bear a vertical pushing force from the tapered gear 21 through the plane bearing can enable the structure of the transmission apparatus more compact and make it not easy to be damaged.

The level three transmission assembly 4 comprises a third gear 41, a fourth gear 42, and a vertical output shaft 43. The third gear 41 meshes the fourth gear 42. The fourth gear 42 receives the vertical output shaft 43. The third gear 41 is connected to the level two transmission assembly, thus, the kinetic energy output of the vertical direction can be realized.

The level four transmission assembly 5 comprises a fifth gear 51, a sixth gear 52, and a horizontal output shaft 53. The fifth gear 51 meshes the sixth gear 52. The fifth gear 51 receives the vertical output shaft 43 of the level three transmission assembly 4. The sixth gear 52 receives the horizontal output shaft 53. Thus, it can maintain the kinetic energy output in a vertical direction and increase the kinetic energy output in a horizontal direction at the same time, through the level four transmission assembly 5. A plurality of functions of one machine can be achieved through using relevant accessories facilities.

The transmission apparatus is arranged in a case 6. The first securing shaft is secured to an inner top portion of the case 6. A front end of the horizontal output shaft 53 fits an assembly hole of one side of the case 6, thereby providing a supporting point for the level one transmission assembly 2 and the horizontal output shaft 53, to make it stronger.

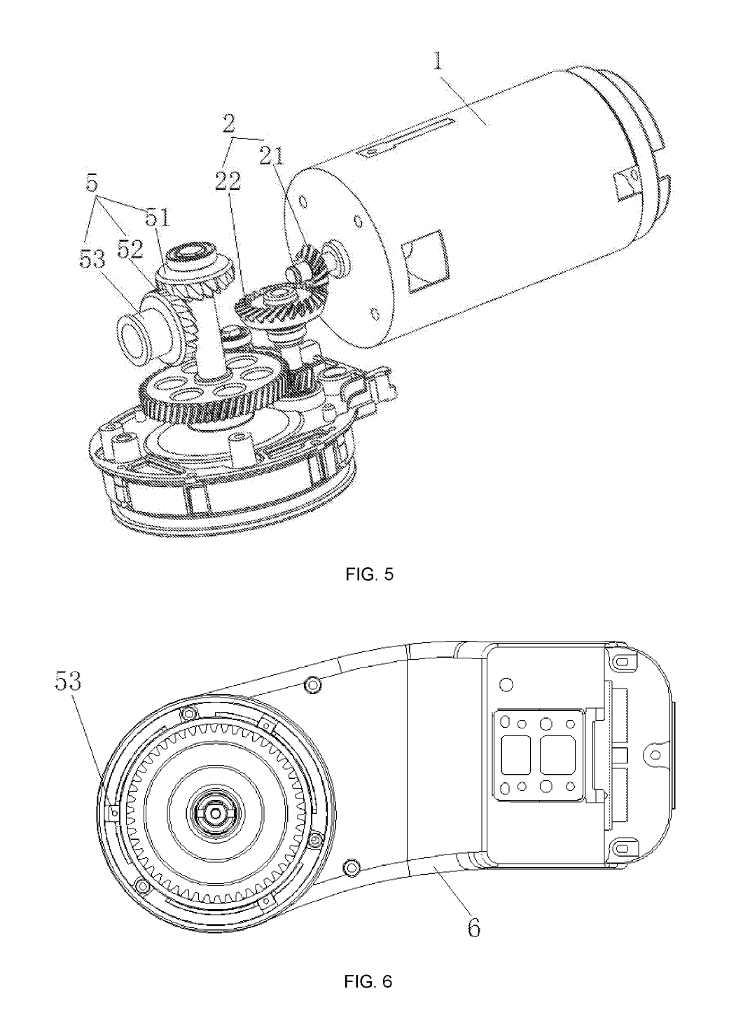

FIGS. 4-5 illustrate a second exemplary embodiment of the transmission apparatus. The transmission apparatus comprises the DC motor 1, the level one transmission assembly 2, the level two transmission assembly 3, the level three transmission assembly 4, and the level four transmission assembly 5. The DC motor 1 is connected to the level one transmission assembly 2, to drive the level one transmission assembly 2 to act. The level one transmission assembly 2 drives the level two transmission assembly 3 to act. The level two transmission assembly 3 drives the level three transmission assembly to act. The level three transmission assembly 4 outputs kinetic energy. The level three transmission assembly 4 transforms a vertical motion into a horizontal motion through the level four transmission assembly 5, to realize to output the kinetic energy, thereby realizing the kinetic energy output in the horizontal and vertical direction at the same time. The DC motor 1 can be used to adjust the speed of the transmission apparatus, thereby enabling the cook machine to meet a variety need of users.

The level one transmission assembly 2 comprises a tapered gear 21, a gear wheel 22, and a first securing shaft. The gear wheel 22 receives the first securing shaft. The tapered gear 21 meshes the gear wheel 22. The tapered gear 21 is connected to an output shaft of the DC motor 1, thus, the tapered gear 21 is directly connected to an output shaft of the DC motor 1, thereby enabling to avoid the use of a belt and a belt wheel, to make the whole structure more compact.

The level two transmission assembly 3 comprises a first gear 31, a second the gear 32, and a second securing shaft. The first gear 31 meshes the second gear 32. The second gear 32 receives the second securing shaft. The first gear 31 and the second gear 32 have a same shaft, thus, the force of the level one transmission assembly 2 can be transmitted through the level two transmission assembly 3.

The first securing shaft receives plane bearing of a vertical force from the tapered gear 21. The plane bearing is located between the gear wheel 22 and the first gear 31. The plane bearing comprises an upper washer, a lower washer, and a ball clip arranged between the upper washer and the lower washer. A bore diameter of the upper washer is less than a bore diameter of the lower washer. Thus, to bear a vertical pushing force from the tapered gear 21 through the plane bearing can enable the structure of the transmission apparatus more compact and make it not easy to be damaged.

The level three transmission assembly 4 comprises a third gear 41, a fourth gear 42, and a vertical output shaft 43. The third gear 41 meshes the fourth gear 42. The fourth gear 42 receives the vertical output shaft 43. The third gear 41 is connected to the level two transmission assembly. Thus, the kinetic energy output in the vertical direction can be realized.

The level four transmission assembly 5 comprises a fifth gear 51, a sixth gear 52, and a horizontal output shaft 53. The fifth gear 51 meshes the sixth gear 52. The fifth gear 51 receives the vertical output shaft 43 of the level three transmission assembly 4. The sixth gear 52 receives the horizontal output shaft 53. Thus, it can maintain the kinetic energy output in the vertical direction and increase the kinetic energy output in the horizontal direction at the same time, through the level four transmission assembly 5. A plurality of functions of one machine can be achieved through using the relevant accessories facilities.

The transmission apparatus is arranged in the case 6. The first securing shaft is secured to an inner top portion of the case 6. A front end of the horizontal output shaft 53 fits an assembly hole of one side of the case 6, thereby providing a supporting point for the level one transmission assembly 2 and the horizontal output shaft 53, to make it stronger.

To optimize transmission ratio, transmission stability, noise, carrying capacity and other parameters of the level one transmission assembly 2, the level two transmission assembly 3, the level three transmission assembly 4 and the level four transmission assembly 5, in the second exemplary embodiment, the tapered gear 21, the gear wheel 22, the fifth gear 51 and the sixth gear 52 use helical bevel gear, the second gear 32 and the third gear 41 use inclined gear, thereby, the level one transmission assembly 2 can reduce a speed of the DC motor 1, and change a transmission direction at the same time; the level two transmission assembly 3 and the level three transmission assembly 4 use combined helical transmission, and have the effect of reducing speed. The level four transmission assembly 5 uses cone gear transmission, to change a transmission direction, the vertical motion is changed to the horizontal motion.

Furthermore, in the exemplary embodiment, not only cylindrical gear transmission, straight bevel gear transmission and helical cone gear transmission, but also single arc gear transmission, biarc gear transmission, curve cone gear transmission, hypoid gear transmission, crossed helical gears inclined gear transmission and other gear transmission ways which can perform the functions described above, are used among the level one transmission assembly 2, the level two transmission assembly 3, the level three transmission assembly 4 and the level four transmission assembly 5. Wherein, both the single arc gear transmission and the biarc gear transmission belong to a circular arc cylindrical gear transmission.

FIG. 6 illustrates one exemplary embodiment of a cook machine. The cook machine comprises the transmission apparatus as mentioned above and a cook machine body. The cook machine body is connected to the transmission apparatus.

A working process is as follows:

The output shaft of the DC motor 1 drives the tapered gear 21 to rotate, the tapered gear 21 drives the gear 22 to rotate; the gear 22 synchronously comprises a first gear 31; the first gear 31 meshes the second gear 32 to drive the second gear 32 to rotate, the third gear 41 is arranged above the second gear 32, the third gear 41 meshes the fourth gear 42 to drive the fourth gear 42 to rotate, the vertical output shaft 43 is located a center of the fourth gear 42, and drives the stiffing knife of the cook machine body to stir. In addition, the fifth gear 51 is arranged on the vertical output shaft 43, the fifth gear 51 meshes the sixth gear 52 to drive the horizontal output shaft 53 of the sixth gear 52 to work, and the vertical motion is changed to the horizontal motion.

Compared with the prior art, when the present technology is used, firstly, with the transmission of the DC motor, the level one transmission assembly, the level two transmission assembly, the level three transmission assembly and the level four transmission assembly, the cook machine can output kinetic energy in a horizontal direction and in a vertical direction at the same time. Thus, one machine is endowed with a variety of machine functions. Secondly, avoid the use of a belt and a belt wheel, to make the whole structure more compact. Finally, the DC motor can be used to adjust the speed of the transmission apparatus, thereby enabling the cook machine to meet a variety need of users.

The exemplary embodiments shown and described above are only examples. Many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A transmission apparatus, comprising:
a direct current (DC) motor;
a level one transmission assembly;
a level two transmission assembly;
a level three transmission assembly; and
a level four transmission assembly;
wherein the DC motor is connected to the level one transmission assembly, to drive the level one transmission assembly to act;
wherein the level one transmission assembly drives the level two transmission assembly to act;
wherein the level two transmission assembly drives the level three transmission assembly to act;
wherein the level three transmission assembly outputs kinetic energy;
wherein the level three transmission assembly outputs kinetic energy and transforms a vertical motion into a horizontal motion through the level four transmission assembly.

2. The transmission apparatus of claim 1, wherein the level one transmission assembly comprises a tapered gear, a gear wheel, and a first securing shaft, the tapered gear meshes the gear wheel, the gear wheel receives the first securing shaft, and the tapered gear is connected to an output shaft of the DC motor.

3. The transmission apparatus of claim 2, wherein the level two transmission assembly comprises a first gear, a second gear, and a second securing shaft, the first gear meshes the second gear, the second gear receives the second securing shaft, and the first gear is coaxial with an output gear of the level one transmission assembly.

4. The transmission apparatus of claim 3, wherein the first securing shaft receives plane bearing for bearing a vertical force from the tapered gear, the plane bearing is located between the gear wheel and the first gear, the plane bearing comprises an upper washer, a lower washer, and a ball clip arranged between the upper washer and the lower washer, a bore diameter of the upper washer is less than a bore diameter of the lower washer.

5. The transmission apparatus of claim 4, wherein the level three transmission assembly comprises a third gear, a fourth gear, and a vertical output shaft, the third gear meshes the fourth gear, the fourth gear receives the vertical output shaft, and the third gear is coaxial with the second gear.

6. The transmission apparatus of claim 5, wherein the level four transmission assembly comprises a fifth gear, a sixth gear, and a horizontal output shaft, the fifth gear meshes the sixth gear, the fifth gear receives the vertical output shaft of the level three transmission assembly, and the sixth gear receives the horizontal output shaft.

7. The transmission apparatus of claim 6, wherein the transmission apparatus is arranged in a case.

8. The transmission apparatus of claim 7, wherein the first securing shaft is secured to an inner top portion of the case.

9. The transmission apparatus of claim 8, wherein a front end of the horizontal output shaft fits an assembly hole of one side of the case.

10. The transmission apparatus of claim 9, wherein each of the tapered gear, the gear, the fifth gear, and the sixth gear, uses a helical bevel gear, both the second gear and the third gear use an inclined gear.

11. The transmission apparatus of claim 1, wherein the level two transmission assembly comprises a first gear, a second gear, and a second securing shaft, the first gear meshes the second gear, the second gear receives the second securing shaft, and the first gear is coaxial with an output gear of the level one transmission assembly.

12. The transmission apparatus of claim 11, wherein the first securing shaft receives plane bearing for bearing a vertical force from the tapered gear, the plane bearing is located between the gear wheel and the first gear, the plane bearing comprises an upper washer, a lower washer, and a ball clip arranged between the upper washer and the lower washer, a bore diameter of the upper washer is less than a bore diameter of the lower washer.

13. The transmission apparatus of claim 12, wherein the level three transmission assembly comprises a third gear, a fourth gear, and a vertical output shaft, the third gear meshes the fourth gear, the fourth gear receives the vertical output shaft, and the third gear is coaxial with the second gear.

14. The transmission apparatus of claim 13, wherein the level four transmission assembly comprises a fifth gear, a sixth gear, and a horizontal output shaft, the fifth gear meshes the sixth gear, the fifth gear receives the vertical output shaft of the level three transmission assembly, and the sixth gear receives the horizontal output shaft.

15. A cook machine comprising the transmission apparatus of claim 1, and further comprising a cook machine body, wherein the cook machine body is connected to the transmission apparatus.

16. The cook machine of claim 15, wherein the level one transmission assembly comprises a tapered gear, a gear wheel, and a first securing shaft, the tapered gear meshes the gear wheel, the gear wheel receives the first securing shaft, and the tapered gear is connected to an output shaft of the DC motor.

17. The cook machine of claim 16, wherein the level two transmission assembly comprises a first gear, a second gear, and a second securing shaft, the first gear meshes the second gear, the second gear receives the second securing shaft, and the first gear is coaxial with an output gear of the level one transmission assembly.

18. The cook machine of claim 17, wherein the first securing shaft receives plane bearing for bearing a vertical force from the tapered gear, the plane bearing is located between the gear wheel and the first gear, the plane bearing comprises an upper washer, a lower washer, and a ball clip arranged between the upper washer and the lower washer, and a bore diameter of the upper washer is less than a bore diameter of the lower washer.

19. The cook machine of claim 18, wherein the level three transmission assembly comprises a third gear, a fourth gear, and a vertical output shaft, the third gear meshes the fourth gear, the fourth gear receives the vertical output shaft, the third gear is coaxial with the second gear.

20. The cook machine of claim 15, wherein the level two transmission assembly comprises a first gear, a second gear, and a second securing shaft, the first gear meshes the second gear, the second gear receives the second securing shaft, and the first gear is coaxial with an output gear of the level one transmission assembly.
